(19) United States
(12) Patent Application Publication
(10) Pub. No.: US 2020/0308884 A1
(43) Pub. Date: Oct. 1, 2020

(54) PADDLE LOCK

(71) Applicant: CHIA-CHENG LIN, YUANLIN CITY (TW)

(72) Inventor: CHIA-CHENG LIN, YUANLIN CITY (TW)

(21) Appl. No.: 16/371,248

(22) Filed: Apr. 1, 2019

(51) Int. Cl. E05B 85/22; E05B 15/04

(52) U.S. Cl. CPC E05B 85/22; E05B 15/04; E05B 81/16; E05B 2015/0437; E05Y 2900/531

(57) ABSTRACT

A paddle lock has a body, a lever, a latch, a locking bolt, and a bolt driving device. The lever is pivotally mounted on the body. The latch is mounted retractably in the body and is connected with the lever. The locking bolt is mounted slidably in the body and has a bolt rod, a retractable head, and a spring. The bolt rod is mounted slidably in the body. The retractable head is connected retractably to an end of the bolt rod and selectively extends out of the body. The spring is connected between the bolt rod and the retractable head. The bolt driving device is mounted in the body and is connected with the bolt rod of the locking bolt to push the locking bolt to extend out of the body or to retract the locking bolt into the body.

### BACKGROUND OF THE INVENTION

### 1. Field of the Invention

The present invention relates to a paddle lock, and more particularly to a paddle lock that has a retractable locking bolt.

### 2. Description of Related Art

A paddle lock is usually mounted on a door panel of a station wagon. A conventional paddle lock substantially comprises a body, a lever, a latch, a locking bolt, and a bolt driving device. The lever is pivotally mounted on the body. The latch is mounted retractably in the body and is connected with the lever. The locking bolt is mounted slidably in the body. The bolt driving device is mounted in the body and is connected with the locking bolt to retract the locking bolt into the body. When the lever is pivoted, the latch can be retracted into the body. Thus, the paddle lock can be unlocked. In addition, when the locking bolt is driven to extend out of the body by the bolt driving device, the paddle lock can be locked to keep the door panel from being opened.

In addition, the bolt driving device of the conventional paddle lock may be electric, such that the bolt lock can be driven to extend out of the body automatically in a predetermined time, such as 10 or 15 seconds by the electric bolt driving device. However, the bolt lock may be driven to extend out of the body automatically when the door panel has not been closed completely. Consequently, the locking bolt will bump against the door fame to cause damage to the locking bolt or the door frame.

To overcome the shortcomings, the present invention tends to provide a paddle lock to mitigate or obviate the aforementioned problems.

### SUMMARY OF THE INVENTION

The main objective of the invention is to provide a paddle lock having a retractable locking bolt to prevent the locking bolt from bumping against a door frame when the locking bolt is in a locked position.

The paddle lock has a body, a lever, a latch, a locking bolt, and a bolt driving device. The lever is pivotally mounted on the body. The latch is mounted retractably in the body and is connected with the lever. The locking bolt is mounted slidably in the body and has a bolt rod, a retractable head, and a spring. The bolt rod is mounted slidably in the body. The retractable head is connected retractably to an end of the bolt rod and selectively extends out of the body. The spring is connected between the bolt rod and the retractable head. The bolt driving device is mounted in the body and is connected with the bolt rod of the locking bolt to push the locking bolt to extend out of the body or to retract the locking bolt into the body.

Other objects, advantages and novel features of the invention will become more apparent from the following detailed description when taken in conjunction with the accompanying drawings.

### BRIEF DESCRIPTION OF THE DRAWINGS

FIG. 1 is a paddle lock in accordance with the present invention;

FIG. 2 is an enlarged perspective view of the paddle lock in FIG. 1;

FIG. 3 is a partially exploded perspective view of the paddle lock in FIG. 1;

FIG. 4 is an enlarged perspective view of a locking bolt and a bolt driving device of the paddle lock in FIG. 1; and

FIG. 5 is a side view in partial section of the locking bolt in FIG. 4.

### DETAILED DESCRIPTION OF PREFERRED EMBODIMENT

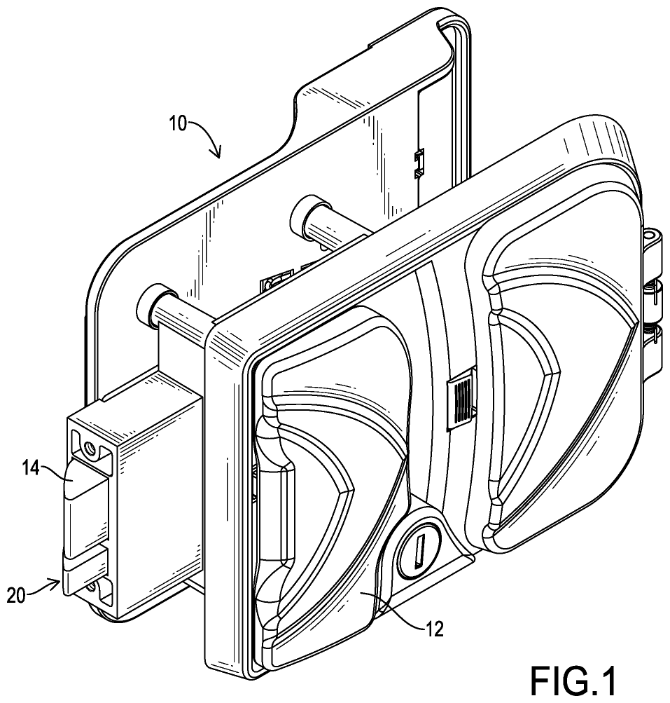

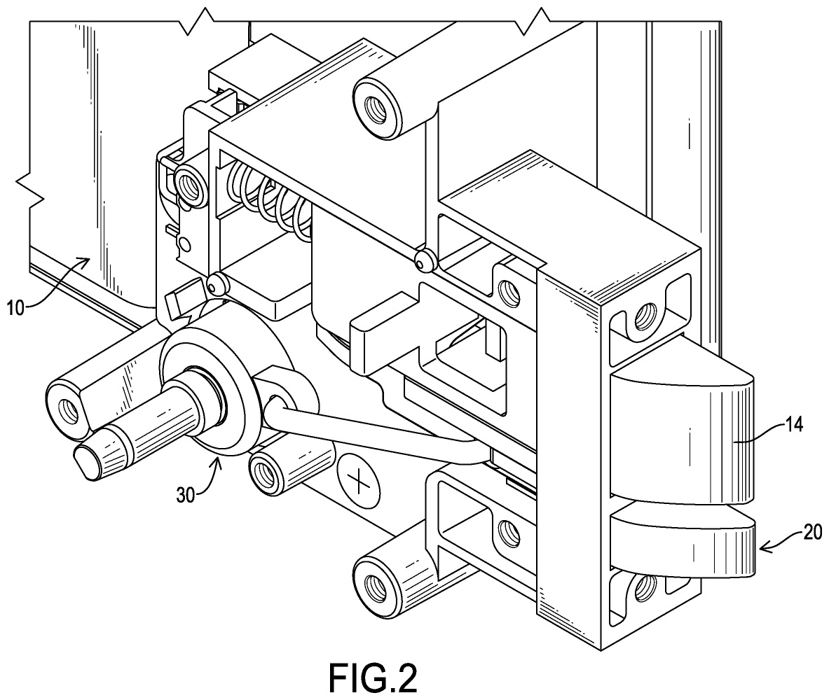

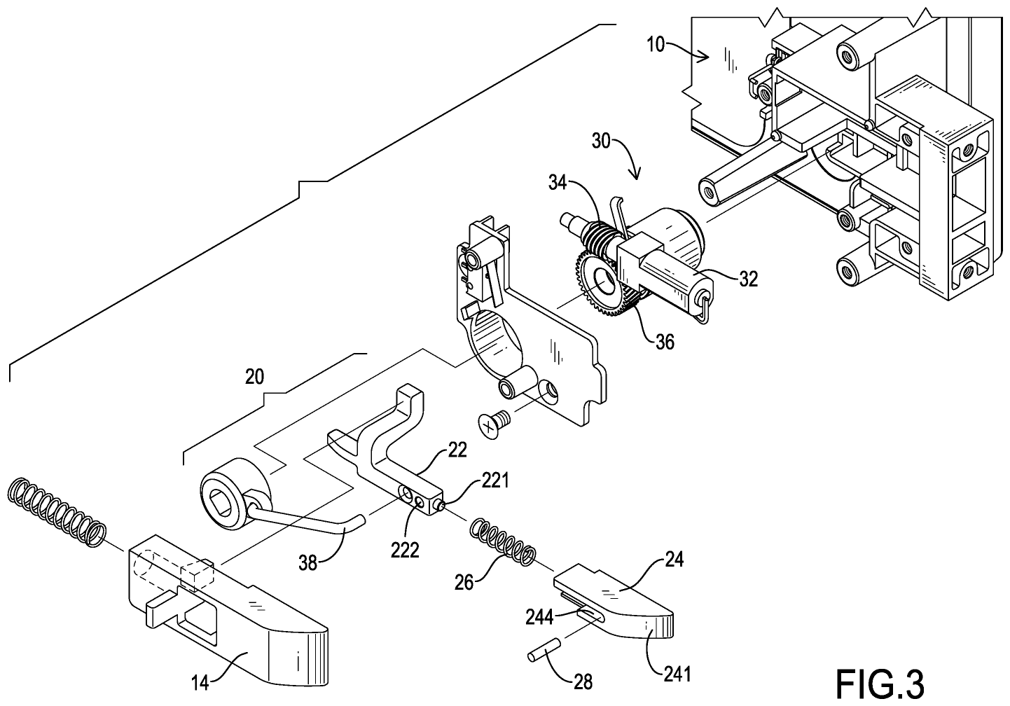

With reference to FIGS. 1 to 3, a paddle lock in accordance with the present invention comprises a body 10, a lever 12, a latch 14, a locking bolt 20, and a bolt driving device 30. The body 10 is adapted to be mounted on a door panel of a vehicle, such as a station wagon. The lever 12 is mounted pivotally on the body 10. The latch 14 is mounted retractably in the body 10 and is connected with the lever 12. The structures of the body 10, the lever 12, and the latch 14 may be conventional, so the detailed description thereof is omitted.

The locking bolt 20 is mounted slidably in the body 10 and comprises a bolt rod 22, a retractable head 24, and a spring 26. The bolt rod 22 is mounted in the body 10. The retractable head 24 is connected retractably to an end of the bolt rod 22 and selectively extends out of the body 10. Preferably, the retractable head 24 has an inclined surface 241 formed on a side of the retractable head 24. In addition, the inclined surface 241 may be curved. The retractable head 24 has a hole 242 defined in an end of the retractable head 24 facing the bolt rod 22 and mounted around the end of the bolt rod 22. The spring 26 is connected between the bolt rod 22 and the retractable head 24. Preferably, the spring 26 is mounted in the hole 242 in the retractable head 24 and has two ends abutting respectively a bottom of the hole 242 and the end of the bolt rod 22. In addition, the bolt rod 22 further comprises a stub 221 formed on and protruding from the end of the bolt rod 22, and one of the ends of the spring 26 is mounted around the stub 221 of the bolt rod 22.

Additionally, the retractable head 24 further has a sliding slot 244 defined in the retractable head 24. The bolt rod 22 has a connecting hole 222 defined in the bolt rod 222 in a position adjacent to the end of the bolt rod 22 and corresponding to the sliding slot 244 in the retractable head 24. A connecting pin 28 is mounted through the sliding slot 244 in the retractable head 24 and is inserted into the connecting hole 222 in the bolt rod 22, such that the retractable head 24 is connected retractably with the bolt rod 22 by the connecting pin 28 and the retractable 24 can be pushed to move relative to the bolt rod 22.

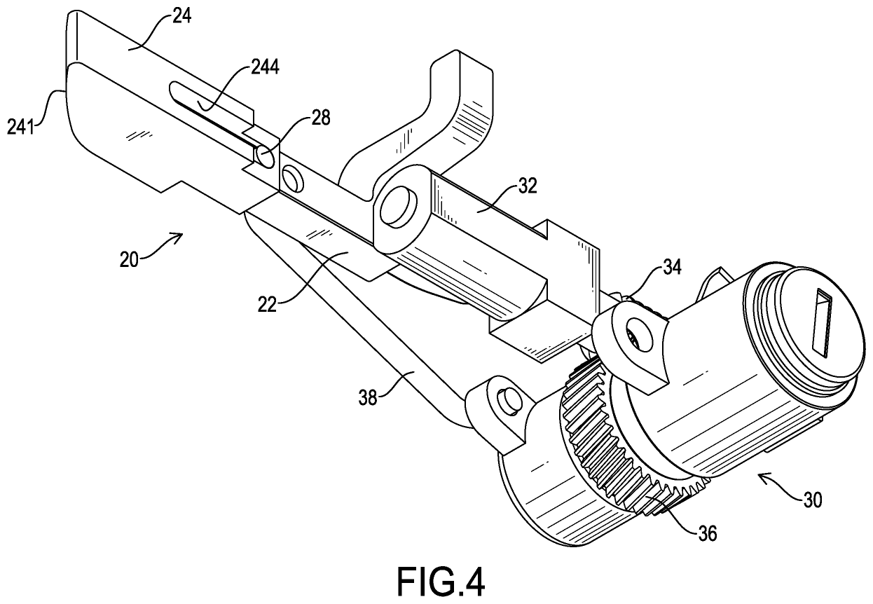

With further reference to FIG. 4, the bolt driving device 30 is mounted in the body 10 and is connected to the locking bolt 20 to push the locking bolt 20 to extend out of the body 10 or retract the locking bolt 20 into the body 10. The bolt driving device 30 may be electric and is electrically connected with a circuit board that is mounted in the body 10. The bolt driving device 30 comprises a motor 32, a worm rod 34, a worm wheel 36, and a connection rod 38. The motor 32 is mounted in the body 10. The worm rod 34 is connected with and driven by the motor 32. The worm wheel 36 is mounted rotatably in the body 10 and is engaged with the worm rod 34. The connection rod 38 is connected between the worm wheel 36 and the bolt rod 22 of the locking bolt 20. Accordingly, when the motor 32 is switched on, the worm wheel 36 is driven to rotate by the transmission of the worm rod 34. When the worm wheel 36 is rotating, the locking bolt 20 is driven to slide to move relative to the body 10 by the transmission of the connection rod 38.

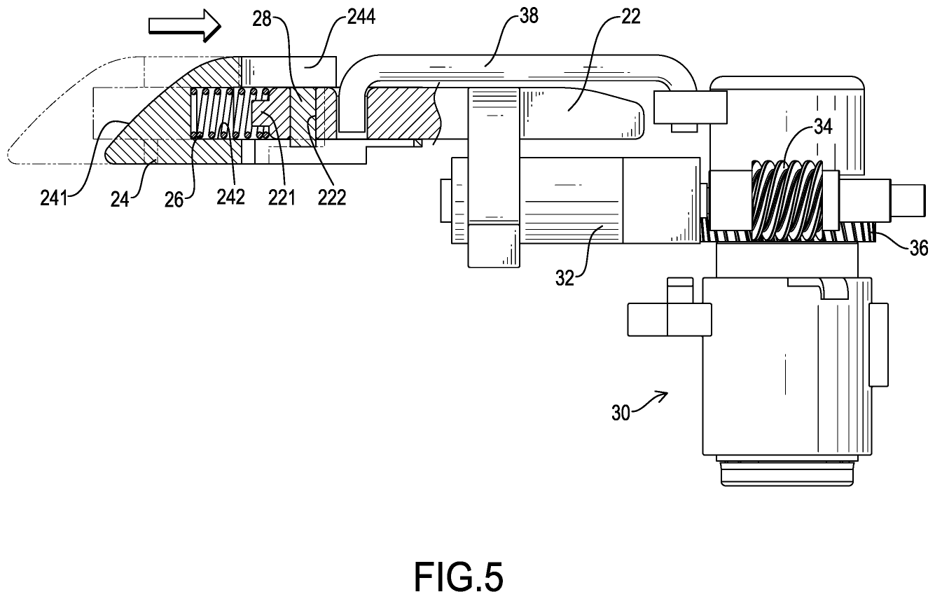

With reference to FIGS. 1 and 5, the locking bolt 20 can be driven to extend out of the body 10 by the bolt driving device 30, such that the paddle lock is in a locked position. Accordingly, the door panel can be kept from being opened even when the lever 12 is pivoted to retract the latch 14 into the body 10. With the electric bolt driving device 30, the locking bolt 20 can automatically extend out of the body 10 to the locked position in a predetermined time after the door panel is closed.

When the locking bolt 20 is in the locked position but the door panel is not closed completely, the locking bolt 20 will bump against the door frame when the door panel is closing. Consequently, with the inclined surface 241 on the retractable head 24 and the retractable movement between the retractable head 24 and the bolt rod 22, the retractable head 24 will be pushed to move relative to the bolt rod 22 when the locking bolt 20 bumps against the door frame and the spring 26 is compressed. When the locking bolt 20 passes over the door frame and is isolated in a locking hole in the door frame, the retractable head 24 can be pushed to insert into the locking hole in the door frame by the force provided by the spring 26 to lock the door panel. Accordingly, the door panel can be closed completely even when the locking bolt 20 is in the locked position, and the locking bolt 20 and the door frame can be kept from being damaged.

To unlock the locking bolt 20, a lock cylinder is connected with the worm wheel 36. When a correct key is inserted into the lock cylinder, the worm wheel 36 can be rotated reversely. Accordingly, the locking bolt 20 can be pulled to retract into the body 10. Alternatively, an electrical signal can be transmitted to the circuit board, and the circuit board can send a signal to the motor 30 to rotate in reverse. Consequently, the locking bolt 20 can be retracted into the body 10 to unlock the locking bolt 20.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A paddle lock comprising:
a body;
a lever pivotally mounted on the body;
a latch mounted retractably in the body and connected with the lever;
a locking bolt mounted slidably in the body and comprising
a bolt rod mounted slidably in the body;
a retractable head connected retractably to an end of the bolt rod and selectively extending out of the body; and
a spring connected between the bolt rod and the retractable head; and
a bolt driving device mounted in the body and connected with the bolt rod of the locking bolt to push the locking bolt to extend out of the body or to retract the locking bolt into the body.

2. The paddle lock as claimed in claim 1, wherein
the retractable head further has a sliding slot defined in the retractable head;
the bolt rod has a connecting hole defined in the bolt rod in a position adjacent to the end of the bolt rod and corresponding to the sliding slot in the retractable head; and
a connecting pin is mounted through the sliding slot in the retractable head and is inserted into the connecting hole in the bolt rod.

3. The paddle lock as claimed in claim 2, wherein the retractable head has an inclined surface formed on a side of the retractable head.

4. The paddle lock as claimed in claim 3, wherein the inclined surface on the retractable head is curved.

5. The paddle lock as claimed in claim 4, wherein
the retractable head has a hole defined in an end of the retractable head facing the bolt rod and mounted around the end of the bolt rod; and
the spring is mounted in the hole in the retractable head and has two ends abutting respectively a bottom of the hole and the end of the bolt rod.

6. The paddle lock as claimed in claim 5, wherein the bolt rod further comprises a stub formed on and protruding from the end of the bolt rod, and one of the ends of the spring is mounted around the stub of the bolt rod.

7. The paddle lock as claimed in claim 1, wherein the retractable head has an inclined surface formed on a side of the retractable head.

8. The paddle lock as claimed in claim 7, wherein the inclined surface on the retractable head is curved.

9. The paddle lock as claimed in claim 8, wherein
the retractable head has a hole defined in an end of the retractable head facing the bolt rod and mounted around the end of the bolt rod; and
the spring is mounted in the hole in the retractable head and has two ends abutting respectively a bottom of the hole and the end of the bolt rod.

10. The paddle lock as claimed in claim 9, wherein the bolt rod further comprises a stub formed on and protruding from the end of the bolt rod, and one of the ends of the spring is mounted around the stub of the bolt rod.

11. The paddle lock as claimed in claim 2, wherein
the retractable head has a hole defined in an end of the retractable head facing the bolt rod and mounted around the end of the bolt rod; and
the spring is mounted in the hole in the retractable head and has two ends abutting respectively a bottom of the hole and the end of the bolt rod.

12. The paddle lock as claimed in claim 11, wherein the bolt rod further comprises a stub formed on and protruding from the end of the bolt rod, and one of the ends of the spring is mounted around the stub of the bolt rod.

13. The paddle lock as claimed in claim 1, wherein
the retractable head has a hole defined in an end of the retractable head facing the bolt rod and mounted around the end of the bolt rod; and
the spring is mounted in the hole in the retractable head and has two ends abutting respectively a bottom of the hole and the end of the bolt rod.

14. The paddle lock as claimed in claim 13, wherein the bolt rod further comprises a stub formed on and protruding from the end of the bolt rod, and one of the ends of the spring is mounted around the stub of the bolt rod.
